(19) United States
(12) Patent Application Publication
(10) Pub. No.: US 2003/0064147 A1
(43) Pub. Date: Apr. 3, 2003

(54) Method for manufacturing flexible printed circuit and flexible printed circuit obtained in the method

(75) Inventors: Hirofumi Fujii, Ibaraki-shi (JP); Koji Matsui, Ibaraki-shi (JP); Hideaki Taki, Ibaraki-shi (JP); Shunichi Hayashi, Ibaraki-shi (JP); Makoto Saito, Ibaraki-shi (JP)

Correspondence Address: SUGHRUE MION, PLLC, 2100 PENNSYLVANIA AVENUE, N.W., WASHINGTON, DC, 20037, US

(73) Assignee: NITTO DENKO CORPORATION

(21) Appl. No.: 10/252,431

(22) Filed: Sep. 24, 2002

(30) Foreign Application Priority Data
Sep. 27, 2001 (JP) P2001-296722

(51) Int. Cl. B05D 5/12; B05D 3/04; B05D 3/10

(52) U.S. Cl. 427/96; 427/301; 427/407.1

(57) ABSTRACT

A method for manufacturing a flexible printed circuit in which a resin solution is applied onto a circuit substrate having a wiring pattern on its surface so as to form a resin cover layer, having the steps of: wetting the surface of the circuit substrate with a solvent which is capable of dissolving the resin; applying the resin solution onto the surface wetted with the solvent; and drying the resin solution to thereby form the resin cover layer. A flexible printed circuit obtained in the manufacturing method.

The present application is based on Japanese Patent Application No. 2001-296722, which is incorporated herein by reference.

### BACKGROUND OF THE INVENTION

1. Field of the Invention

The present invention relates to a method for manufacturing a flexible printed circuit for use in electronic parts, electronic equipment, etc., and a flexible printed circuit obtained in the method.

2. Description of the Related Art

Fundamentally, flexible printed circuits have a structure in which a resin cover layer (hereinafter, occasionally referred to as “cover layer”) is formed on the surface of a circuit substrate having wiring patterns while the surface of the circuit substrate is partially exposed in appropriate portions to which circuit components are to be mounted so that the circuit components can be electrically connected. As the method for forming the cover layer, in the related art, there is generally adopted a method in which a resin film with an adhesive having holes formed in advance is hot-pressed to be laminated to a circuit substrate so that the resin film is formed as a cover layer.

In the flexible printed circuits formed thus, foreign matters are apt to adhere to the adhesive in the manufacturing process. Accordingly, the foreign matters stays behind between the wiring patterns after the cover layer is formed by lamination. Thus, there is a tendency that the yield ratio of the flexible printed circuits deteriorates. In addition, there is such a disadvantage that the adhesive oozes through the holes at the time of contact bonding the resin film.

Instead of a method based on lamination of such a resin film, there has been proposed a method in which a resin solution is applied directly onto a circuit substrate and then dried so as to be formed as a cover layer. In this method, since no adhesive is used and no step of hot-pressing is included, these disadvantages are avoided. However, according to the method, there may appear portions where the resin solution is not packed between wiring patterns. After drying, such portions may form voids in the portions of the cover layer close to the circuit substrate surface (close to the wiring patterns) also in an end product. Thus, there is a problem that the voids have an adverse influence on the electric property or the mechanical property of the flexible printed circuit.

### SUMMARY OF THE INVENTION

The present invention was developed to solve the foregoing problems. It is an object of the invention to provide a method for manufacturing a flexible printed circuit in which a resin solution is applied onto the surface of a circuit substrate and dried so as to form a resin cover layer, with the result that occurrence of voids in the resin cover layer can be suppressed. It is another object of the invention to provide a flexible printed circuit obtained in the manufacturing method with an excellent electric property and an excellent mechanical property.

As a result of diligent investigations to solve the foregoing problems, the present inventor et al. accomplished the invention. That is, the invention is just as follows.

(1) A method for manufacturing a flexible printed circuit in which a resin solution is applied onto a circuit substrate having a wiring pattern on its surface so as to form a resin cover layer, having the steps of: wetting the surface of the circuit substrate with a solvent which is capable of dissolving the resin; applying the resin solution onto the surface wetted with the solvent; and drying the resin solution to thereby form the resin cover layer.

(2) A flexible printed circuit obtained in a manufacturing method defined in (1).

Features and advantages of the invention will be evident from the following detailed description of the preferred embodiments described in conjunction with the attached drawings.

### BRIEF DESCRIPTION OF THE DRAWING

In the accompanying drawings:

FIG. 1 is a view simply showing a mechanism suitable particularly for carrying out a manufacturing method according to the invention; and

FIG. 2 is a view simply showing wiring patterns formed in an embodiment.

### DETAILED DESCRIPTION OF THE PREFERRED EMBODIMENTS

The invention will be described below in detail.

The method for manufacturing a flexible printed circuit according to the invention is a method for manufacturing a flexible printed circuit in which a resin solution is applied onto a circuit substrate having a wiring pattern on its surface so that a resin cover layer (cover layer) is formed. This method includes at least the step 1) of wetting the circuit substrate surface with a solvent which is capable of dissolving resin used in the resin solution, the step 2) of applying the resin solution onto the circuit substrate surface wetted with the solvent, and the step 3) of drying the resin solution.

The resin solution in the invention may be a solution of resin showing an excellent insulating property in the end form of a cover layer after appropriate treatment such as heating or hardening which will be described later, or may be a solution of a precursor of the resin. Examples of such resin include polyamic acid resin as polyimide resin precursor, epoxy resin, maleimide resin, nadimide resin, polyamide resin, polyamide-imide resin, and mixtures of those resins. As a solvent for dissolving the resin in the resin solution, various solvents known in the related art may be used in accordance with the kind of resin. When the resin is a polyamic acid resin, examples of the solvent include polar organic solvents such as N-methyl-2-pyrrolidone, N,N-dimethylacetamide, N,N-dimethylformamide, dimethyl sulfoxide, and hexamethylenephosphoramide.

The concentration of the resin solution is preferably 5 wt % to 95 wt %, more preferably 10 wt % to 50 wt %. When the concentration of the resin solution is lower than 5 wt %, the viscosity of the resin solution becomes so low that it is difficult to keep a predetermined film thickness on the substrate after application. Thus, there is an unfavorable tendency that unevenness occurs also in the film thickness after drying. On the contrary, when the concentration of the resin solution exceeds 95 wt %, the feed rate of the resin is reduced. Thus, there is an unfavorable tendency that it is difficult to perform application with a uniform film thickness.

In the manufacturing method of the invention, the solvent for wetting the circuit substrate before application of the resin solution to the circuit substrate is not limited particularly, so long as the solvent is a solvent which is capable of dissolving the resin in the resin solution. A solvent for resin used widely in this field can be used suitably. Though the solvent differs in accordance with the kind of the resin, examples of such a solvent include polar organic solvents such as N-methyl-2-pyrrolidone, N,N-dimethylacetamide, N,N-dimethylformamide, dimethyl sulfoxide, and hexamethylenephosphoramide, when the resin is a polyamic acid resin. The solvent may be a mixture of two or more kinds of solvents if the mixture is capable of dissolving the resin. As the solvent, a solvent the same as or different from the solvent used in the resin solution may be used. Further, a mixture containing, as main components, a solvent the same as the solvent used in the resin solution and a solvent different from the solvent used in the resin solution may be used.

Unless the solubility of the resin is not inhibited, the solvent may be added with additives such as a dissolution accelerator such as a variety of polyethylene glycols, phenolic resin, or novolac resin; a boiling point modifier such as an azeotropic solvent, a high-boiling solvent, or a low-boiling solvent; and a surface active agent including a non ionic surface active agent such as a variety of polyoxyethylenes, an ampholytic surface active agent such as long-chain alkyl amyl acid, or a cationic surface active agent such as quaternary ammonium salt.

The method for wetting the surface of the circuit substrate with a solvent in the step 1) of the invention is not limited particularly. Incidentally, the word “wetting” in the invention means a phenomenon that liquid thrusts gas away from the surface of a solid. Then, the words “wetting the surface of the circuit substrate with a solvent” mean that a solvent is attached to the surface of the circuit substrate so as to thrust gas away from the surface of the circuit substrate. Examples of such a method include various methods such as a method of applying a solvent to the surface of the circuit substrate, a method of spraying a misty solvent, and a method of dipping the substrate into a solvent.

On the other hand, as the method for applying a resin solution onto the circuit substrate having a surface wetted with the solvent in the step 2) of the invention, various methods known in the related art can be used suitably. There can be preferably adopted a method capable of continuously applying the resin solution to a long substrate having a wiring pattern, such as a comma coating method, a fountain coating method, a curtain coating method, or a doctor blade coating method.

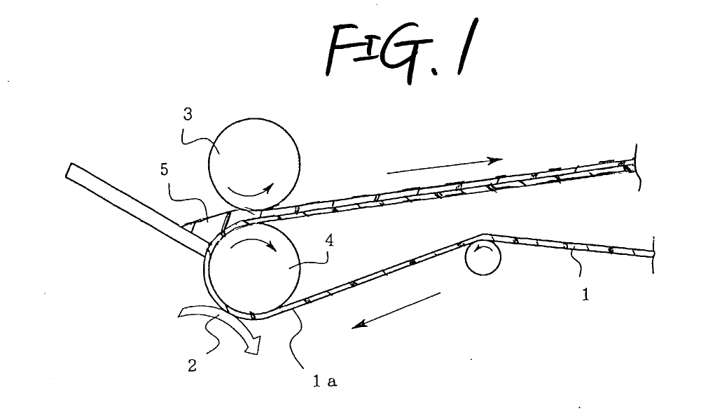

FIG. 1 is a view simply showing a mechanism particularly suitable for carrying out the manufacturing method of the invention. According to the mechanism shown in FIG. 1, the step 1) and the step 2) can be performed successively so that the manufacturing method of the invention can be implemented with high workability.

In the example of FIG. 1, while conveying a circuit substrate 1 in which a wiring pattern has been formed in advance by use of a comma coating method, a surface 1a (surface on the side where the wiring pattern has been provided) of the circuit substrate 1 is wetted with a solvent by a solvent supply unit (not shown) as shown schematically by the outline arrow sign 2 in FIG. 1. After that, a resin solution 5 is applied to the circuit substrate 1 by comma rolls 3 and 4. The solvent supply unit is, for example, implemented by at least one nozzle capable of spraying a solvent onto the surface of the circuit substrate. In addition, the mechanism shown in FIG. 1 may be implemented so that a solvent recovery unit (not shown) for recovering an excessive solvent supplied to the circuit substrate surface by the solvent supply unit is further provided at a location downstream of the solvent supply unit with respect to the direction in which the circuit substrate is conveyed.

The speed of conveying the circuit substrate 1 in FIG. 1 is not limited particularly. However, from the balance between the speed in which the resin solution can be supplied stably and the speed in which the substrate can be conveyed stably, the circuit substrate 1 is conveyed preferably at a speed of 0.1 m/min to 1.5 m/min, more preferably at a speed of 0.5 m/min to 1 m/min.

The method for drying the solvent and the resin solution on the circuit substrate in the step 3) of the invention is not limited particularly. Various methods known in the related art can be adopted suitably. The conditions of drying vary in accordance with the kinds of the solvent of the resin solution, the kind of the solvent, the kind of the resin, the quantity of the resin solution applied, and so on. For example, drying is performed at a temperature of 70° C.-130° C. for 2 minutes to 20 minutes by use of a dryer capable of carrying out a floating method with a drying furnace length of 2 m.

Incidentally, when the mechanism in FIG. 1 is implemented so that a dryer (not shown) for carrying out the step 3) which will be described later is further provided at a location downstream of the comma rolls 3 and 4 with respect to the direction in which the circuit substrate is conveyed, the steps 1) to 3) in the manufacturing method of the invention can be carried out successively while conveying the circuit substrate. Thus, the workability is further improved preferably.

According to the manufacturing method of the invention, a cover layer is formed on the circuit substrate through the steps 1) to 3) as described above. Thus, a flexible printed circuit is manufactured. The flexible printed circuit manufactured thus according to the invention has a cover layer having no voids in the portions near the circuit substrate surface (near the wiring pattern). It is considered that this is because the surface of the circuit substrate is wetted with a solvent in advance before the resin solution generally having a high viscosity is applied thereto, with the result that the resin solution can be carried all over the surface of the circuit substrate having a wiring pattern and therefore having irregularities formed thereon, when the resin solution is applied thereto. The flexible printed circuit according to the invention, having such a cover layer having no voids, can surely attain the inherent purpose as a cover layer to protect the wiring pattern from an external impact and to present an insulating property to the wiring pattern. Thus, the flexible printed circuit according to the invention has an excellent electric property and an excellent mechanical property in comparison with related-art flexible printed circuits obtained by merely applying a resin solution to the surface of a circuit substrate.

Incidentally, the “excellent electric property” in the flexible printed circuit according to the invention means that the moisture resistance (insulating property) measured in accordance with a measuring method (migration test) established in IPC-TM-650 2.6.3 is not lower than 10⁹ Ω by way of example. On the other hand, the “excellent mechanical property” in the flexible printed circuit according to the invention means that the number of bends (providing the bending radius (φ) is 3.17 mm, the weight is 8 oz, and the bending frequency is 1 Hz) measured in accordance with a measuring method established in Ductility Test of IPC-TM-650 2.4.33 is not smaller than 10⁴ times by way of example. In addition, in the flexible printed circuit according to the invention, corrosion is difficult to occur in the wiring pattern. For example, even after treatment for 168 hours under the conditions of 121° C. and 2 atmospheres by use of a pressure cooker tester, the metal forming the wiring pattern can be prevented surely from being corroded.

The cover layer in the flexible printed circuit according to the invention is formed into a substantially uniform thickness including manufacturing errors or irregularities caused by the wiring pattern. In the flexible printed circuit according to the invention, the thickness of the cover layer is preferably 5 μm to 100 μm, more preferably 10 μm to 20 μm, from the point of view of moisture resistance, mechanical strength and flexibility. When the thickness of the cover layer is smaller than 5 μm, there is an undesirable tendency for the mechanical strength to deteriorate. On the contrary, when the thickness of the cover layer exceeds 100 μm, there is an undesirable tendency to damage the flexibility that is one of the features of the flexible printed circuit.

In the manufacturing method according to the invention, after the respective steps 1) to 3), heat treatment or treatment for hardening the resin may be given to the resin in accordance with necessity.

The circuit substrate in the invention is not limited particularly. Any suitable circuit substrate usually used in this field may be used. A subtractive method or an additive method known in the related art can be mentioned as a preferred method for forming the wiring pattern on the substrate.

When the wiring pattern is formed in the subtractive method, for example, metal foil having a double-layer structure in which an insulating resin base is formed on metal foil is etched selectively by photo-resist so as to form the wiring pattern. It is preferable that the metal foil used is an electrically good conductor. For example, the metal foil may be foil of metal such as copper, nickel, aluminum, copper-beryllium, or phosphor bronze, or foil of an alloy of those metals. The thickness of the metal foil is preferably 3 μm to 100 μm, more preferably 5 μm to 20 μm. When the thickness of the metal foil is smaller than 3 μm, there is an undesirable tendency for the electric resistance to increase and for the wiring pattern to be mechanically broken easily. On the contrary, when the thickness of the metal foil exceeds 100 μm, there is an undesirable tendency to make it difficult to form the wiring pattern so as to prevent the wiring pattern from being fined.

On the other hand, when the wiring pattern is formed in the additive method, for example, a thin film of metal is formed on an insulating resin base in a sputtering method, a vapor deposition method, an electroless plating method, or the like. Pattern plating is performed on the metal thin film by use of photo-resist, and further the metal thin film is removed by etching. Thus, the wiring pattern is formed (semi-additive method) . It is preferable that the metal has a low electric resistance. For example, plating with metal such as copper, nickel or aluminum, or plating with an alloy of those metals maybe used. The thickness of the metal thin film is preferably 3 μm to 100 μm, more preferably 5 μm to 20 μm. When the thickness of the metal thin film is smaller than 3 μm, there is an undesirable tendency for the electric resistance to increase and for the wiring pattern to be mechanically broken easily. On the contrary, when the thickness of the metal thin film exceeds 100 μm, the metal thin film becomes thicker than the photo-resist so that the wiring may be short-circuited undesirably.

When either the subtractive method or the additive method is used to form the wiring pattern in the invention, it is, for example, preferable that a polyimide film or a PET film is used as the insulating resin base. The thickness of the insulating resin base is preferably 5 μm to 100 μm, more preferably 10 μm to 50 μm. When the thickness of the insulating resin base is smaller than 5 μm, there is an undesirable tendency for the obtained flexible printed circuit to deteriorate in mechanical strength. On the contrary, when the thickness of the insulating resin base exceeds 100 μm, there is an undesirable tendency for the obtained flexible printed circuit to lack flexibility so that it hardly plays a role as a flexible printed circuit.

The invention will be described below more specifically along its examples. However, these examples are merely exemplary, and set no limit to the scope of the invention.

### EXAMPLE 1

(1) Formation of Circuit Substrate

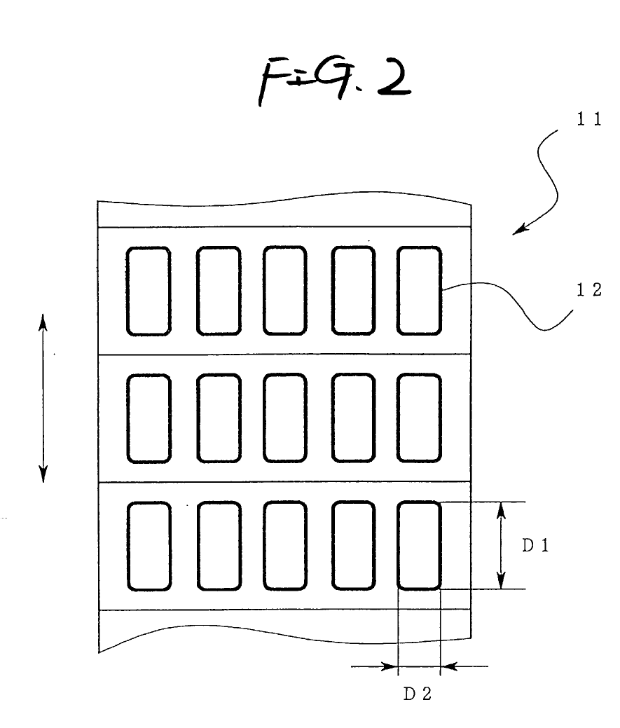

A circuit substrate 11 having circuit patterns 12 (L/S(Line/Space)=200/200(μm/μm)(L×4)), D1=80 mm, D2=30 mm) as simply shown in FIG. 2 was formed on a long double-layer structure (250 mm wide) in which an insulating resin base (25 μm thick) made of polyimide resin had been formed on copper foil (18 μm thick), in a subtractive method known in the related art.

(2) Preparation of Resin Solution

One mol of p-phenylenediamine was reacted with 1 mol of 3,3′,4,4′-biphenyl tetracarboxylic anhydride in 2,280 g of N-methyl-2-pyrrolidone (NMP) so as to prepare an NMP solution of polyamic acid resin whose concentration was 15 wt %.

(3) Production of Cover Layer

By use of an apparatus having a mechanism simply shown in FIG. 1, 1) N-methyl-2-pyrrolidone was fed to the surface of the circuit substrate having the wiring patterns formed therein, so as to wet the surface, and successively 2) the resin solution formed in the paragraph (2) was applied onto the circuit substrate surface at a rate of 0.5 m/min by a comma coater. After that, 3) the resin solution applied on the circuit substrate surface was dried in a drying furnace at 100° C. while being conveyed as it was. Thus, a resin layer 25 μm thick was formed. The resin layer was heat-treated at 400° C. in nitrogen together with the circuit substrate, so that the polyamic acid resin was hardened to form a cover layer. Thus, a sample of a flexible printed circuit was produced.

### EXAMPLE 2

A sample of a flexible printed circuit was produced in the same manner that in Example 1, except that an NMP solution of polyamic acid resin obtained as follows was used as the resin solution. That is, 1 mol of 4,4′-diaminodiphenyl ether was reacted with 1 mol of tetracarboxylic anhydride in 2,196 g of N-methyl-2-pyrrolidone so as to prepare an NMP solution of polyamic acid resin whose concentration was 15 wt %.

### EXAMPLE 3

A sample of a flexible printed circuit was produced in the same manner that in Example 1, except that N,N-dimethylacetamide (DMAc) was used as the solvent for wetting the circuit substrate surface therewith and the solvent for the resin solution.

### EXAMPLE 4

A sample of a flexible printed circuit was produced in the same manner that in Example 1, except that each wiring pattern was formed with a pattern width of L/S=100/100 (μm/μm).

### Comparative Examples 1 to 4

Samples of flexible printed circuits were produced in the same manner as those in Examples 1 to 4 respectively, expect that the step 1) of wetting the circuit substrate surface with a solvent was not carried out.

The following evaluation tests 1 to 4 were carried out on the respective samples of Example 1 to 4 and Comparative Examples 1 to 4.

(1) Evaluation Test 1: Number of Voids

The number of voids in the cover layer in each sample was measured visually and by use of an optical microscope (5-100 magnifications) . Incidentally, the number of voids was obtained by averaging the numbers of voids existing in each of the patterns (number of the pattern measured: n=30) shown in FIG. 2. The result is shown in the table.

(2) Evaluation Test 2: Corrosion

Each sample was treated at 121° C. and 2 atmospheres for 168 hours by use of a pressure cooker tester. Then, the wiring patterns made of copper were observed so that the existence of corrosion was checked (identified visually from the discoloration of the copper surface). The result is shown in the table.

Further, each sample of Comparative Example 1 to 4 was cut off in its thickness direction (substantially perpendicular to its longitudinal direction and its width direction) after the observation. When the cut surface was observed in each sample, the corrosion occurred in the portion where voids were generated, and the thickness of the cover layer in the portion in question was not larger than 1 μm.

(3) Evaluation Test 3: Migration Test

For each sample, a resistance value (Ω) after 100 hours under the conditions of 100 V, 85° C. and 85% (humidity) was obtained by use of a comb test pattern shown by IPC-B-25A established in IPC-TM-650 2.6.3.

(4) Evaluation Test 4: Flexibility Test

For each sample, the number of bends was measured under the conditions of the bending radius (φ) 3.17 mm, the weight 8 oz, and the bending frequency 1 Hz by use of a pattern recommended in IPC-TM-650 2.4.3.1. Incidentally, L/S in each sample was just as described above, and the number of lines L was 9.

The results of the evaluation tests 1 to 4 are shown in the following table.

| | | | | | Comparative | Comparative | Comparative | Comparative |
|---|---|---|---|---|---|---|---|---|
| | Example 1 | Example 2 | Example 3 | Example 4 | Example 1 | Example 2 | Example 3 | Example 4 |
| resin solution solvent | NMP | NMP | DMAc | NMP | NMP | NMP | DMAc | NMP |
| solvent | NMP | NMP | DMAc | NMP | NMP | NMP | DMAc | NMP |
| L/S (μm/μm) | 200/200 | 200/200 | 200/200 | 100/100 | 200/200 | 200/200 | 200/200 | 100/100 |
| number of voids | 0 | 0 | 0 | 0 | 18 | 23 | 17 | 31 |
| existence of corrosion | no | no | no | no | yes | yes | yes | yes |
| migration test (Ω) | 2.5 × 10¹⁰ | 2.3 × 10¹⁰ | 2.6 × 10¹⁰ | 2.0 × 10¹⁰ | 1.7 × 10⁷ | 3.1 × 10⁷ | 5.2 × 10⁷ | 7.3 × 10⁶ |
| flexibility test | 2 × 10⁵ | 1.5 × 10⁵ | 2 × 10⁵ | 2 × 10⁵ | <10⁴ | <10⁴ | <10⁴ | <10⁴ |
| (times) | | | | | | | | |

As is apparent from the description, according to the invention, it is possible to provide a method for manufacturing a flexible printed circuit in which generation of voids in a resin cover layer can be suppressed, and a flexible printed circuit obtained in the manufacturing method with an excellent electric property and an excellent mechanical property.

Although the invention has been described in its preferred form with a certain degree of particularity, it is understood that the present disclosure of the preferred form can be changed in the details of construction and in the combination and arrangement of parts without departing from the spirit and the scope of the invention as hereinafter claimed.

What is claimed is:

1. A method for manufacturing a flexible printed circuit in which a resin solution is applied onto a circuit substrate having a wiring pattern on its surface so as to form a resin cover layer, comprising steps of:
wetting said surface of said circuit substrate with a solvent which is capable of dissolving said resin solution;
applying said resin solution onto said surface wetted with said solvent; and
drying said resin solution to thereby form said resin cover layer.

2. A method for manufacturing a flexible printed circuit according to claim 1, wherein said solvent is same as a solvent used in said resin solution.

3. A method for manufacturing a flexible printed circuit according to claim 1, further comprising a step of recovering an excessive solvent between said wetting step and said applying step.

4. A method for manufacturing a flexible printed circuit according to claim 1, further comprising a step of conveying said circuit substrate at a speed of 0.1 m/min to 1.5 m/min.

5. A method for manufacturing a flexible printed circuit according to claim 4, wherein said circuit substrate is conveyed at a speed of preferably at a speed of 0.5 m/min to 1 m/min.

6. A method for manufacturing a flexible printed circuit according to claim 1, wherein said wetting step is at least selected from the group consisting of a step of applying a solvent to said surface of said circuit substrate, a step of spraying a misty solvent on said circuit substrate, and a step of dipping said circuit substrate into said solvent.

7. A method for manufacturing a flexible printed circuit according to claim 1, wherein said applying step is continuously applying said resin solution to a long substrate having a wiring pattern.

8. A method for manufacturing a flexible printed circuit according to claim 7, wherein said step of continuously applying said resin solution to the long substrate is at least selected from the group consisting of a comma coating method, a fountain coating method, a curtain coating method and a doctor blade coating method.

9. A method for manufacturing a flexible printed circuit according to claim 1, wherein said drying step is performed at a temperature of 70° C. to 130° C. for 2 minutes to 20 minutes.

10. A flexible printed circuit obtained in a manufacturing method according to claim 1.
